(19) United States
(12) Patent Application Publication
(10) Pub. No.: US 2023/0048879 A1
(43) Pub. Date: Feb. 16, 2023

(54) METHOD AND SYSTEM FOR ORGANNIZATION DURING MOVING AND STORAGE

(71) Applicant: SOCALGAL BRANDS, LLC, DRAPER, UT (US)

(72) Inventor: MICHELLE RUESCH, LEHI, UT (US)

(73) Assignee: SOCALGAL BRANDS, LLC, DRAPER, UT (US)

(21) Appl. No.: 17/888,987

(22) Filed: Aug. 16, 2022

Related U.S. Application Data
(60) Provisional application No. 63/233,728, filed on Aug. 16, 2021.
(60) Provisional application No. 63/368,022, filed on Jul. 8, 2022.
(60) Provisional application No. 63/394,280, filed on Aug. 1, 2022.

(51) Int. Cl. G06K 7/14; G06Q 10/08; G06Q 30/06; G09F 3/02

(52) U.S. Cl. CPC G06K 7/1408; G06Q 10/087; G06Q 30/0621; G09F 3/0288

(57) ABSTRACT

A storage system may comprise a common characteristic label comprising a first scannable code correlated to a first catalogue information and at least one origin or destination label having a second scannable code correlated to a second catalogue information. The storage system may comprise a smart device having a processor, a memory, and a transceiver, and may receive an input from a camera. The smart device may receive scans of the first scannable code and of the second scannable code, and receive the first catalogue information and the second catalogue information, respectively. The processor may associate the second catalogue information with the first catalogue information. The processor may access origin or destination data associated with the first catalogue information and/or second catalogue information. The smart device may receive images of stored items. The memory may store images and the processor may associate the images with the first catalogue information.

### CROSS-REFERENCE TO RELATED APPLICATIONS

This application claims the benefit of pending U.S. Provisional Patent Application No. 63/233,728, filed Aug. 16, 2021, of pending U.S. Provisional Patent Application No. 63/368,022, filed Jul. 8, 2022, and of pending U.S. Provisional Patent Application 63/394,280, filed Aug. 1, 2022.

### BACKGROUND OF THE INVENTION

Many systems exist for organizing items for short term or extended storage. Most system are manual, and few have implemented computer-aided systems for organizing items. Despite that, systems still lack in functionality and convenience.

### SUMMARY OF THE INVENTION

In some embodiments, a storage system is disclosed. The storage system may comprise at least one common characteristic label comprising a first scannable code correlated to a first catalogue information. The storage system may comprise at least one origin or destination label having a second scannable code correlated to a second catalogue information. The storage system may comprise a smart device having a processor, a memory, and a transceiver, the smart device may be operable to receive an input from an image capture device, wherein the smart device may be operable to receive from an image capture device a scan of each of the first scannable code, and receive the first catalogue information, and of the second scannable code, and receive the second catalogue information. The processor may be operable to associate the second catalogue information with the first catalogue information. The processor may be operable to access, from the memory, origin data associated with the second catalogue information. The processor may be operable to access, from the memory, origin or destination data associated with the first catalogue information. The smart device may be operable to receive, from an image capture device, images of items stored in the at least one container. The memory may be operable to store the images and wherein the processor associates, in the memory, the images with the first catalogue information.

In some embodiments, a method of organizing storage information is disclosed.

The method may comprise scanning, via an image capture device, a first scannable code on at least one label representing a common characteristic of items. The method may comprise receiving a first catalogue information associated with the first scannable code, at the processor. The method may comprise scanning, via an image capture device, a second scannable code on at least one container label. The method may comprise receiving a second catalogue information associated with the second scannable code, at the processor. The method may comprise storing within a memory, the first catalogue information with the second catalogue information. The method may comprise associating, via a processor, the second catalogue information with the first catalogue information. The method may comprise accessing, via the processor, from a memory, common characteristic data associated with the first catalogue information. The method may comprise accessing, from the memory, origin or destination data associated with the second associated informational code.

In some embodiments, a system for organizing information related to the organization and storage of items is disclosed. The system may comprise a smart device, comprising a processor and a memory. The smart device may be operable to receive a first input related to a first catalogue information where the first catalogue information may be correlated to a common characteristic of items and a second input related to a second catalogue information, wherein the second catalogue information may be related to at least one of an origin or a destination of items sharing the common characteristic. The system may comprise wherein the smart device may store, in the memory, the first catalogue information and the second catalogue information. The smart device may associate, via the processor, the first catalogue information with the second catalogue information. The system may comprise a data entry portal operable to receive information from a first user input regarding the first catalogue information and the second catalogue information. The system may comprise a portal accessible by a second user on a separate device. The access point may enable the second user to view data entered by the first user. The second device may be operable to access, from a memory, data associated with the first catalogue information and the second catalogue information.

### BRIEF DESCRIPTION OF THE DRAWINGS

Some embodiments of the present invention are illustrated as an example and are not limited by the figures or measurements of the accompanying drawings, in which like references may indicate similar elements and in which:

FIGS. 1a-1c depict a system for organization and storage, in accordance with the various embodiments of the present invention.

FIG. 2 illustrates a block diagram depicting an architecture for implementing an organization and storage system in a smart device, in accordance with some embodiments of the present invention.

FIG. 3 depicts a flow diagram depicting a method of operation of hands-free multi-lingual online communication system, in accordance with various embodiments of the present invention.

FIGS. 4a-4g illustrate exemplary user interfaces of the organization and storage system implemented at a mobile device, in accordance with various embodiments of the present invention

FIG. 5 illustrates an exemplary cloud architecture for implementation of an organization and storage system, in accordance with some embodiments of the present invention.

FIG. 6 illustrates an exemplary computer program product that is configured to provide and support an organization and storage system, in accordance with various embodiments of the present invention.

FIG. 7 is a block diagram illustrating an exemplary computing device that is configured to provide and support organization and storage system, in accordance with various embodiments of the present invention.

### DETAILED DESCRIPTION OF DRAWINGS

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

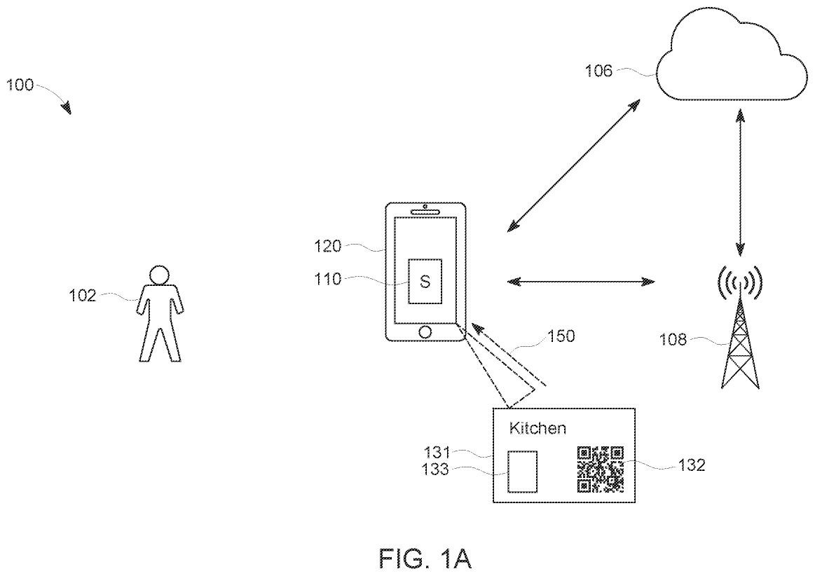

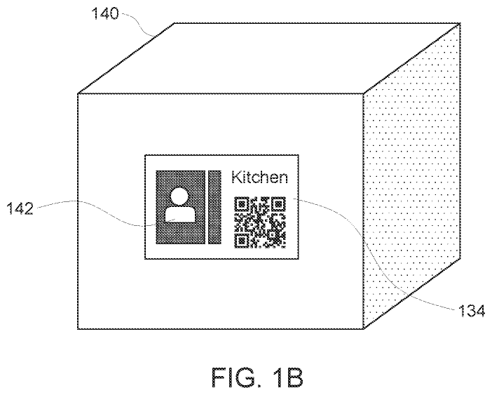

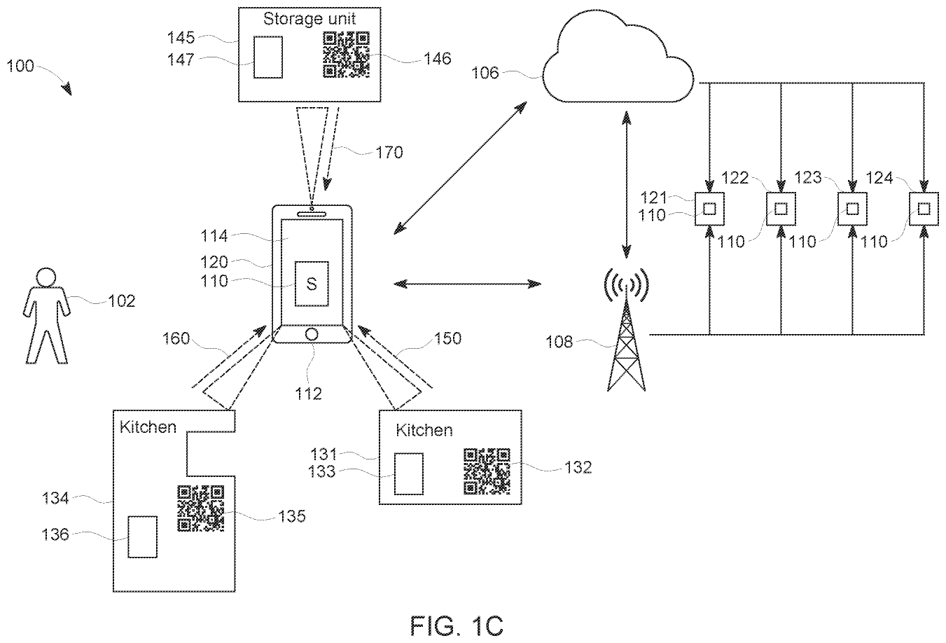

FIG. 1a depicts a system 100 for organizing items for temporary or extended storage, in accordance with the various embodiments described herein. In accordance with the various embodiments described herein, the system 100 may include an application, represented by icon 110, and further described below. The application 110 may be operable to be installed on a smart device, such as smart device 120 to be used by a user 102. The smart device 120 may comprise a processor, a memory, and a transceiver operable to send and receive signals from an outside source.

The application 110 may comprise processor executable instructions, which, upon execution, may be configured to catalogue and organize information related to personal or business items for multiple circumstances. For example, in some embodiments, the application 110 may be utilized with items to be moved, such as during the process of moving personal and/or business items from one location to another. In some embodiments, application 110 may be utilized with items to be stored temporarily, such as during a home or business moving from one location to another. In some embodiments, the application 110 may be utilized with items that are to be stored on an extended basis, as described herein.

Some embodiments may include the application 110 being configured to be accessed via a downloaded application or via web application or via a website available through a web-browser on the smart device 120. While FIG. 1a depicts the smart device 120, it may be apparent to a person skilled in the art that the smart devices 120 may include any electronic communication device capable of installation of a mobile application or running a web browser to access internet. For example, the smart device 120 may include, but not limited to, a mobile communication device, a laptop, a desktop, etc.

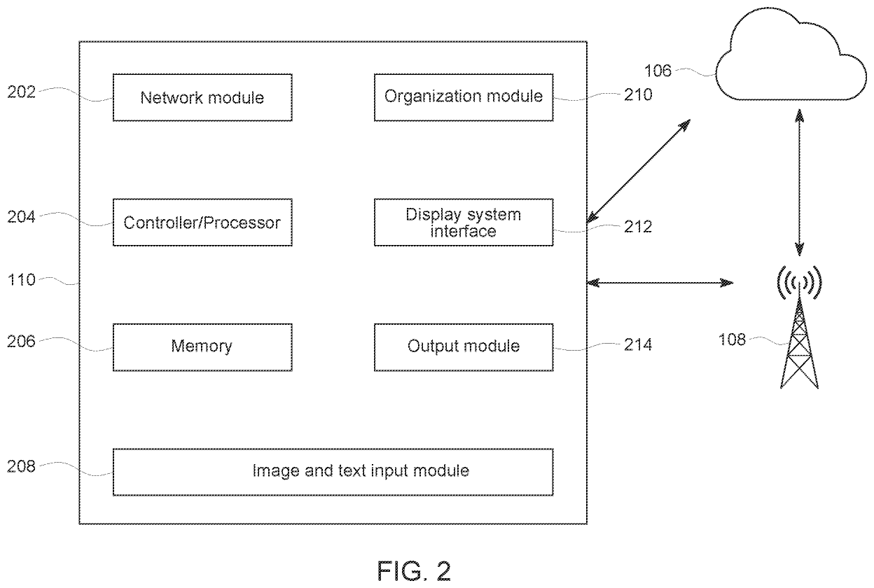

In some embodiments, the smart device 120 may comprise, or may be operably connected to an image capture device 112, such as a camera. The image capture device 112 may be operably connected to a processor and a memory within smart device 120, as shown in FIG. 2.

Some embodiments of the system 100 may comprise a first label 131. The first label 13 may comprise a sticker having an adhesive which may be temporarily or permanently adhered to a container.

The first label 131 may comprise a first scannable code 132 or a first associated informational code. The first scannable code 132 may comprise a quick response code (QR code), a bar code, or other code operable to be scanned. The first scannable code 132 may comprise information, such as a first catalogue information 150, as will be discussed herein below. The first scannable code 150 may be operable, via the first catalogue information 150, to identify a container wherein items to be moved or stored may be placed. For example, in some embodiments, the first scannable code 132 may indicate a container in which items having a common characteristic may be placed. The common characteristic may comprise the origin of the items such as a room or location in an office or a home. The common characteristic may comprise the final destination of the items, such as, for example, a room or a location at the destination office or the destination home, such as “kitchen” or “break room”. The common characteristic may comprise the name of the owner of the items, the purpose of the items, or other common characteristic.

Some embodiments may include wherein the first scannable code 132 indicates the area of extended storage, such as “garage” or, for example, “bedroom closet”. The first label 131 may be operable to be positioned in a conspicuous location so as to be easily identifiable to a mover or an individual searching for the location of stored items.

Some embodiments may include the first label 131 further comprising a first alternate identifying marker 133. The first alternate identifying marker 133 may comprise a color, a shape a three-dimensional portion, such as braille, or other identifying feature.

Referring to FIG. 1b, FIG. 1b illustrates the first label 131 being coupled to a container 140. The first label 131 may be coupled to the container 140 by adhesives, removable adhesives, or by a protective label cover. In some embodiments, the first label 131 may further comprise an advertisement 142 for an individual or a company. For example, a real estate agent may provide totes for his or her clients that are moving from one home to another home. The first label 131 attached to the container 140 may display the real estate agent's brand, face, or other identifying marker.

In some embodiments, the containers 140 may comprise plastic reusable containers. The containers may comprise single or limited use cardboard boxes. The containers may comprise any box, tote, bin, or other container made from any material.

In some embodiments, the container 140 may be rented, such as when moving items from one location to another. In some embodiments, the container 140 may be purchased, such as when the container 140 is being used for extended storage.

Referring now to FIG. 1c, some embodiments of the system 100 may comprise a second label 134. The second label 134 may comprise a room label that is operable to identify a room or location where items from a container, such as container 140, may be placed. For example, the second label 134 may comprise a hanger operable to hang on a doorknob or a label having a removable adhesive, such that the second label 1344 may be detachably coupled to a door, wall, cabinet, shelf, or other structure.

The second label 134 may comprise a second scannable code 135. The second scannable code 135 may comprise a quick response code (QR code), a bar code, or other code operable to be scanned. The second scannable code 135 may comprise information, such as a second catalogue information 160, as will be discussed herein below. The second scannable code 135 may be operable, via the second catalogue information 160, to identify a room or location where containers having a corresponding label or code may be placed. For example, in some embodiments, the second scannable code 135 may indicate a location within a new home or business location, such as “kitchen” or “break room”. As described below, containers correlated to or with the second scannable code 132 may be directed to the kitchen or break room, respectfully.

Some embodiments may include the second label 134 further comprising a second alternate identifying marker 136. The second alternate identifying marker 136 may comprise a color, a shape a three-dimensional portion, or other identifying feature. The second alternate identifying marker 136 may be coordinated with the first alternate identifying marker 133, such as, for example, the first alternate identifying marker 133 and the second alternate identifying marker 136 may each comprise an area colored in red, blue, or other color to aid movers in easily identifying the appropriate room in which to place a box. As a further example, the first alternate identifying marker 133 and the second alternate identifying marker 136 may each comprise an area colored in red, blue, or other color to aid a person to know in/on which closet or shelf a box having a particular item may be stored.

Some embodiments of the system 100 may include a sheet or multiple sheets containing pre-printed first labels and pre-printed first labels. Each of sheets containing the pre-printed first label and the pre-printed second label may comprise a pre-printed scannable code, a pre-printed color, which may cover the entire label, and a blank space for a filling in the respective room (i.e., kitchen, bedroom 1, living room, bathroom 1, etc.). In some embodiments, the room name may be pre-printed as well. In some embodiments, the color may cover only a portion of the label. In some embodiments, the color may cover the entire label.

Some embodiments may include the room name being printed or written on the label, either next to or on top of the color. As a non-limiting example, FIG. 1a and FIG. 1c illustrate the room “Kitchen” being written on the first label 131 and the second label 134.

Some embodiments of the system 100 may comprise a third label 145. The third label 145 may comprise a label that is operable to identify a location where a container, such as container 140, is to be placed for transport, temporary storage, or extended storage. For example, the third label 145 may comprise a sticker or a hanger operable to be coupled with a storage location

The third label 145 may comprise a third scannable code 146. The third scannable code 146 may comprise a quick response code (QR code), a bar code, or other code operable to be scanned. The third scannable code 146 may comprise information, such as a third catalogue information 170, as will be discussed herein below. The third scannable code 146 may be operable, via the third catalogue information 170, to identify a storage location where particular containers, such as the container 140, may be stored for a temporary or an extended time period.

The storage location may be a general location. The storage location may be a specific location. For example, in some embodiments, the third scannable code 135 may indicate a storage location such as a building. In some embodiments, the third scannable code 135 may indicate a storage location within such a building, such as a specific room. In some embodiments, the third scannable code 135 may indicate a closet and/or a shelf within such a specific room. In some embodiments, as will be discussed herein below, the storage location, general or specific, may be assigned to the third catalogue information 170 after the third scannable code 146 has been scanned by smart device 120.

In some embodiments. the storage location nay be a storage unit, a garage, or a moving truck. The storage location may be indicated by the third catalogue, information 170 that may be scanned into the application 110 or, in some embodiments may be entered as text into the application 110.

Some embodiments may include the third label 145 further comprising a third alternate identifying marker 147. The third alternate identifying marker 147 may comprise a color, a shape a three-dimensional portion, or other identifying feature. The third alternate identifying marker 136 may be coordinated with the first alternate identifying marker 133. In some embodiments, the third alternate identifying marker 147 may be coordinated with the first alternate identifying marker 133. In some embodiments, the third alternate identifying marker 147 may be coordinated with the first alternate identifying marker 133 and with the second alternate identifying marker 136.

Some embodiments of the system 100 may include a sheet or multiple sheets containing pre-printed first labels and pre-printed first labels. Each of sheets containing the pre-printed first label and the pre-printed second label may comprise a pre-printed scannable code, a pre-printed color, which may cover the entire label, and a blank space for a filling in the respective room (i.e., kitchen, bedroom 1, living room, bathroom 1, etc.). In some embodiments, the room name may be pre-printed as well. In some embodiments, the color may cover only a portion of the label. In some embodiments, the color may cover the entire label.

Some embodiments may include the room name being printed or written on the label, either next to or on top of the color. As a non-limiting example, FIG. 1a and FIG. 1c illustrate the room “Kitchen” being written on the first label 131 and the third label 145.

Referring still to FIG. 1c, in some embodiments, the smart device 120 may be operable to scan, via an image capture device 112 operably coupled with each of the first scannable code 133 and the second scannable code 135. The smart device 120 may be operable to receive the first catalogue information 150. The first catalogue information 150 may be received by the application 110 installed on the smart device 150. The first catalogue information 150 may comprise an information received from scanning the first scannable code 133, using the at least one image capture device operably coupled with the smart device 120.

The first catalogue information may indicate a container in which items having a common characteristic may be placed. The common characteristic may comprise the origin of the items such as a room or location in an office or a home. The common characteristic may comprise the final destination of the items, such as, for example, a room or a location at the destination office or the destination home, such as “kitchen” or “break room”. The common characteristic may comprise the name of the owner of the items, the purpose of the items, or other common characteristic.

In some embodiments, the first catalogue information 150 may comprise information regarding a common characteristic of items that may be placed within a container, such as container 140. The common characteristic may comprise the origin of the items such as a room or location in an office or a home. The common characteristic may comprise the final destination of the items, such as, for example, a room or a location at the destination office or the destination home, such as “kitchen” or “break room”. In some embodiments, the common characteristic may comprise a storage location of temporary or permanent storage for the container 140. The common characteristic may comprise the name of the owner of the items, the purpose of the items, or other common characteristic. In some embodiments, the common characteristic may be assigned to the items by the user 102. For example, a color may be assigned to items associated with the first catalogue information 150.

In some embodiments, the first catalogue information 150 may comprise information regarding and/or detailing the location where items associated with the first label 131, and the associated first scannable code 133 are to be deposited in a new location, either permanent or temporary. For example, the first catalogue information 150 may comprise information regarding where items are to be placed upon arriving at a moving destination or where such items may be stored for temporary or extended periods.

In some embodiments the first catalogue information 150 may comprise information The first catalogue information 150 may be prestored in a memory 206 (as shown in FIG. 2) of the smart device 120. In some embodiments, when smart device 120 is used to scan the first scannable code 133 within the application 110, the application 110 will retrieve from the memory 206 any pre-assigned common characteristic associated with the first scannable code 133 and the associated or correlated first catalogue information 150. Such pre-assigned common characteristic may comprise a location, a storage location, a color, or may be unassigned, and/or may be editable by user 102. Scanning the first scannable code 133 may open a window on a display of the first smart device 120, the window showing information regarding the first catalogue information 150.

In some embodiments, additional information may be associated with the first catalogue information 150. For example, the image capture device 112 may capture images of items having a common characteristic and that are to be stored in the same container. Such images may be stored in the memory 206 of the smart device 120 and may be accessible to view via the display of the smart device 120 from within the application 110, and, specifically when accessing the information associated with the first catalogue information 150.

In some embodiments, the application 110 may produce a menu on which a user may record or create, within the application 110, text describing items that may be stored within a container, such as the container 140. For example, the text may comprise the item name, an item description, a description of the item's condition, its condition, its owner, its value, and any other information which may be relevant to the item. This may be repeated for each item sharing a common characteristic to be stored within the same container. In some embodiments, the application 110 may produce a menu having specific fillable fields for certain information, such as, for example value of an item.

In some embodiments the text descriptions of an item may be associated with the first catalogue information 150 and may be stored in the memory of the smart device 120. The text information may be viewable at a later time when accessing the application 110, in a manner similar to that described above related to the images.

In some embodiments, the application 110 may be operable to receive a second catalogue information 160. The second catalogue information 160 may comprise an information received from scanning the second scannable code 135, using the at least one image capture device from the smart device 120. The second scannable code 135 may contain information regarding the second label 134.

The second scannable code 135 and the associated second catalogue information 160 may be prestored in a memory of the smart device 120. In some embodiments, the second scannable code 135 and the associated second catalogue information 160 may be associated with or correlated to the first scannable code 131 and the first catalogue information 150. For example, the first scannable code 132 may be used to identify items having a common characteristic related to the location where the items will be moved to in a destination home or office. The second scannable code 135 may be used to identify a location where such items will be moved to. In such a scenario, the common characteristic, and the identifier of the second scannable code 135 overlap. The application 110 is operable to recognize such an overlap and create an association between the first catalogue information 150 and the second catalogue information 160.

Scanning the second scannable code 135 while a window on the display 114 of the smart device 120 is open showing information related to the first catalogue information 150 may trigger an automatic association between the first catalogue information 150 (i.e., the first label 131, identifying the container) and the second catalogue information 160 (i.e., the second label 130, identifying a location), such that the second catalogue information 160 is associated with the first catalogue information 150.

In some embodiments, the association between the second catalogue information 160 and the first catalogue information 150 may be manually created by user 102 within the application 110, allowing the user 102 to select a name of a location associated with the second catalogue information 150. The first catalogue information 150 and/or the second catalogue information 160 may, in some embodiments, be associated with an assigned identifier, such as a number. The assigned identifier may comprise a composite identifier, consisting of multiple parts and may be automatically assigned or may be manually entered. For example, the assigned identifier may comprise an identifier of the team or individual in the first portion of the composite and may comprise a number of the storage container in the second portion of the composite. Further, in some embodiments, the first catalogue information 150 and the second catalogue information 160 may not be scanned, and the user 102 may enter the information regarding location and storage container into the application 110.

In some embodiments, the application 110 may be operable to receive a third catalogue information 170. The third catalogue information 170 may comprise an information received from scanning the third scannable code 146, using the at least one image capture device 112 from the smart device 120. In some embodiments, the third scannable code 146 may contain information regarding the third label 145. In some embodiments, the third scannable code 146 may be found in a place other than a label. In some embodiments, the third scannable code 146 may be found on a piece of paper, a display screen, or other location.

The third scannable code 146 and the associated third catalogue information 170 may be prestored in a memory of the smart device 120. In some embodiments, the third scannable code 146 and the associated third catalogue information 170 may be associated with or correlated to the first scannable code 131 and the first catalogue information 150. For example, the first scannable code 132 may be used to identify items having a common characteristic related to the ownership of the items identified by the first scannable code 132 and the first catalogue information 150. The third scannable code 146 may be used to identify a storage location where such items will be stored, within the container bearing the first scannable code 132, for a short term, temporary term, and/or an extended term. A temporary or short storage space may comprise a moving van or, a trailer, or other short-term storage. A long-term storage may comprise a long-term storage facility, a garage, a closet, or other location where items may be stored for a longer period of time.

in some embodiments, the storage location may be a storage unit, a garage, or a moving truck. The storage location may be indicated by a third catalogue information that may be scanned into the application 110 or, in some embodiments may be entered as text into the application 110. In some embodiments, the third catalogue information 170, which corresponds to the third scannable code 146, may be correlated with, or associated with the first catalogue information manually by a user within the application 110, such that a user need not scan the third scannable code 146 in order to create an association with the first catalogue information 132.

Scanning the third scannable code 146 while a window on the display 114 of the smart device 120 is open showing information related to the first catalogue information 150 may trigger an automatic association between the first catalogue information 150 (i.e., the first label 131, identifying the container) and the third catalogue information 170 (i.e., the second label 130, identifying a location), such that the third catalogue information 170 is associated with the first catalogue information 150.

In some embodiments, the association between the third catalogue information 170 and the first catalogue information 150 may be manually created by user 102 within the application 110, allowing the user 102 to select a name of a storage location associated with the third catalogue information 170. The first catalogue information 150 and/or the third catalogue information 170 may, in some embodiments, be associated with an assigned identifier, such as a number. The assigned identifier may comprise a composite identifier, consisting of multiple parts and may be automatically assigned or may be manually entered. For example, the assigned identifier may comprise an identifier of the team or individual in the first portion of the composite and may comprise a number of the storage container in the second portion of the composite. Further, in some embodiments, the first catalogue information 150 and the third catalogue information 170 may not be scanned, and the user 102 may enter the information regarding location and storage container into the application 110.

In some embodiments, the first catalogue information 150, the second catalogue information 160, the third catalogue information 170 may all be correlated with or associated each other.

Some embodiments may include the smart device 120 being operably coupled to cloud architecture 106.

The application 110 installed at the smart device 120 may be configured to store a plurality of first scannable codes to provide information regarding multiple rooms. Similarly, the application 110 may be configured to store a plurality of second scannable codes with multiple data entries for each second scannable code, i.e., container codes, which will allow a user to enter the contents or inventory associated with multiple containers.

The application 110 may further comprise a location map and/or a list of locations. The location may be accessible through the user interface and may provide a graphical display in the form of a map of all locations where items will be moved to or stored, such as kitchen, bedroom, living room, break room, office, etc. The location map within the application 110 may display a color to correspond to the location, the first label 131, and the second label 134. For example, if the kitchen is identified by the first label 131 and the first alternate identifying marker 133 in the color red, and the corresponding containers identified by the second label 134 has the corresponding second alternate identifying marker 135 also bearing the color red, then the location map may display the kitchen in red within the application 110. The location map may be printable through the application 110, and the physical map may be placed in certain locations, such as doors and entryways, in the new residence or office to help instruct movers to find various locations throughout a building.

In some embodiments, the invention may include assigning a color to an alternative category. In some embodiments, a color within the application 110 may be assigned to a broad category or particular categorization. For example, instead of assigning a color to a room, a user may assign a color within the application 110 program associated with a storage box to a person. In some embodiments, other categorizations may include a size or sizes of a storage container, type of material the container is made of, the type of items contained within a tote (for example Christmas decorations).

The application 110 may be fully customizable in that the user 102 may specify the location where an item came from, which container items are in, what items are in the container, and where the container is physically at any given time.

Alternatively, in some embodiments, the user 102 may indicate, for organizational reasons, the type of item (for example, decorations) which specific container certain items are in, what items are in the container, and where the container is at any given time

In some embodiments, an additional catalogue information may be input into the application 110 to indicate a current physical location of storage containers. The additional catalogue information may be associated with a scannable code, such as a QR code. For example, the location of a storage container may be catalogued and recorded within a particular moving truck, or a particular storage facility, including a location within a storage facility, such as a particular row, storage rack, and/or shelf on such a storage rack, or locations within particular storage locations.

Alternatively, in some embodiments, the user 102 may indicate, for organization reasons, who a particular item or items belong to, which specific container certain items are in, what items are in the container, and where the container is at any given time.

Alternatively, in some embodiments, the user 102 may indicate, for organizational reasons, a customized category of items or a customized common characteristic between items, such as salvageable or non-salvageable (for example, in disaster cleanup situations where an insurance company must determine what is salvageable and what must be replaced), or winter clothing, or size of container, which specific container certain items are in, what items are in the container, and where the container is at any given time. The application 110 may also receive, either through user input or automatic input, such as via the world wide web, a value to each item being stored.

The various catalogue informations stored within the application 110, as described herein, enables the application 110 to maintain a chain of custody, always tracking the location of items and enabling an assurance of responsibility for the items in question.

Referring again to FIG. 1c, some embodiments may include wherein smart device 120 is operably coupled with cloud architecture 106. The information recorded on the memory 206 of smart device 120, including the first catalogue information 132, the second catalogue information 132, and the third catalogue information 170, and all of the text, pictures, pricing information, organizational information, and all other information associated with the first catalogue information 150, the second catalogue information 160, and the third catalogue information 170 may be communicated to the cloud architecture 106. Such information may he stored in the cloud architecture 106 and may be communicated back to smart device 120, or may be communicated to other devices, servers, or smart devices. Further, smart device 120 may receive information from the cloud architecture 106 or from other devices, smart devices, and servers, via connection with the cloud architecture 108.

Some embodiments may include wherein smart device 120 is operably coupled with a network 108. The network 108 may include, but may not be limited to, any wired or wireless network, such as a radio network, LAN, or WAN, in accordance with various embodiments of the present invention. The information recorded on the memory 206 of smart device 120, including the first catalogue information 150, the second catalogue information 160, and the third catalogue information 170, and of the text, pictures, pricing information, organizational information, and all other information associated with the first catalogue information 150, the second catalogue information 160, and the third catalogue information 170 may be communicated via the network 108 to various other devices, servers, or smart devices. Further, smart device 120 may receive information from other devices, smart devices, and servers, via connection with network 108

In some embodiments, a user 102 may use the system offline and may upload any newly entered data or contents at a later time when a connection with the network 108 or with the cloud architecture 106 is available.

Referring again to FIG. 1c some embodiments may include wherein multiple smart devices may have access to view and, in some embodiments edit, the information in the application 110. For example, in some embodiments, smart device 121 may be operably coupled with the cloud architecture 106 and/or the network 108. Smart device 121 may receive, at a transceiver, information into application 110, which may be installed on smart device 121 Smart device 121 may comprise a memory and a processor. The memory may store the information received. The smart device 121 may display the information receive via the application 110. Smart device 121 may comprise an architecture, functionality, and modules similar to the architecture and modules of smart device 110, as described herein, and as shown in FIG. 2.

Some embodiments may include additional smart devices being operably coupled with the cloud architecture 106 and/or the network 108. For example, smart device 122, smart device 123, and smart device 124 may be operably coupled with the cloud architecture 106 and/or the network 108 and may comprise application 110 being installed thereon. In some embodiments, the application 110 on smart device 122, smart device 123, and smart device 124, respectively, may comprise different permissions than the application 110 on smart device 120 may comprise. For example, smart device 120 may have full access rights, while smart device 121 may have viewing rights, and while smart device 122 may have editing rights, and while smart device 123 may have limited viewing rights or limited editing rights and while smart device 124 may have full access rights.

In some embodiments, many users may have access to view or edit a particular account, and rights may be fully granted or limited in any number of ways. The viewing rights or editing rights may be controlled, and upgraded or downgrade, by the owner of the account or a user of the account with the proper access.

Referring now to FIG. 2, FIG. 2 illustrates a block diagram 200 depicting an architecture for implementing an organizational and storage system in a smart device 120, in accordance with some embodiments of the present invention.

The block diagram architecture 200 may comprise a network module 202, a controller/processor 204, a memory 206, a training module 208, a converter/translation module 210, a display system interface 212, and an output module 214.

The network module 202 may be configured to facilitate data exchange between the smart device 120 and the cloud architecture 106, or between the smart device 120 and the network 108 and the cloud architecture 106. As shown in FIG. 1a, FIG. 1c, and FIG. 2, the network 108 and the cloud architecture 106 may be in communication with each other, such that information in the cloud architecture 106 and in the network 108 may be communicated back and forth.

The controller/processor 204 controls operations of all components of the application 110 at the smart device 120, in accordance with various embodiments of the present invention. Specifically, the controller/processor 204 may be configured to execute program instructions stored in the memory 206 to perform the processes of the application 110 of the smart device 120 smart device 120. For example, the controller/processor 204 may be configured to receive optical and textual inputs, organize the inputs, transmit the messages, display/read the messages, display information according to instruction, etc.

The image and text input module 208 may be configured to receive images via an image capture device, such as a camera, which may be integrated with the smart device 120, or may be operably connected, via wires or wirelessly, to the smart device 120. The module may also be operable to receive text descriptions of labels or contents of containers via a keyboard, w which may be integrated with the smart device 120 or may be operably connected, via wires or wirelessly, to the smart device 120. The keyboard may be displayed on a touch screen. In some embodiments, the text may he received verbally as well, via a microphone operably connected to or integrated with the smart device 120.

The organization module 210 may be configured to organize the prestored data, such as rooms or storage location information and the received images and text locally within the application 110 at the smart device 120. In an alternative embodiment, organization module 210 may be configured to organize the received images and text using an organization function available at the cloud architecture 106. The organization module may be operable to organize the prestored data or information and the newly stored data or information and the received information and data, such that the data is searchable via the display system interface. For example, if a user 102 needed to know in what container the flatware was located, the user could enter the word “flatware” into a search function. The application 110 could then inform the user as to which container, and in which room, the flatware is located.

The display system interface 212 may be configured to display the interface of the application 110 at the smart device 120. For example, the display system interface may display a room or storage location list, a container list, an item list, or a list categorized by any common characteristic, in accordance with various embodiments of the present invention.

The output module 214 may he configured to output messages from the application 110 of the smart device 120 for transmitting to the cloud architecture 106 or to the network 108. The network 108 may include, but may not be limited to, any wired or wireless network, such as a radio network, LAN, or WAN, in accordance with various embodiments of the present invention. In some embodiments, the system described herein may be connected to a network and the information may be stored in the cloud architecture 106, in some embodiments, a user 102 may use the system offline and may upload any newly entered contents at a later time when a network connection is available.

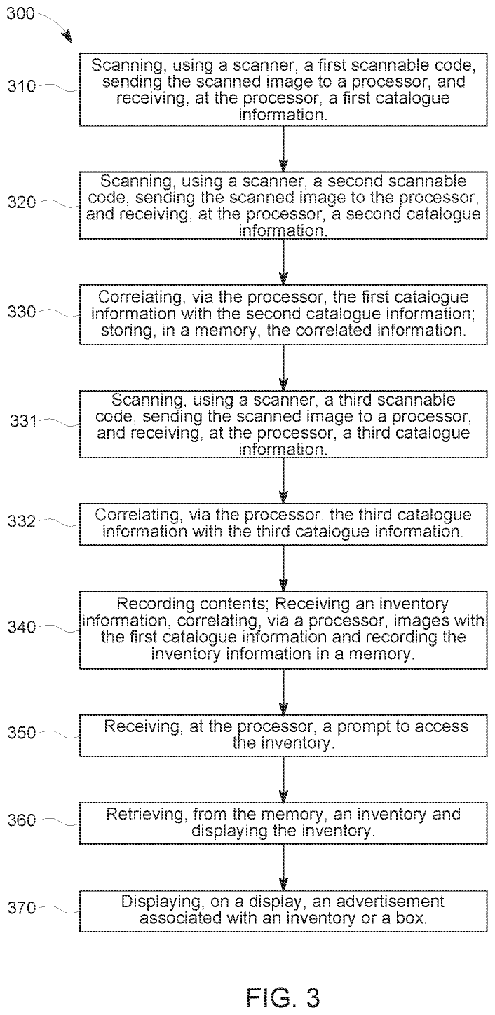

FIG. 3 illustrates a flowchart detailing a method of using the system described herein. Some embodiments may comprise a method 300 of cataloguing inventory data. Some embodiments may comprise wherein the inventory data includes an inventory of items to be stored either temporarily, such as, for example household or commercial items being stored during the process of moving, or, in other embodiments, storage of items for extended periods.

Some embodiments may include the method comprising step 310, scanning, or capturing, via an image capture device, an image of a first scannable code, the first scannable code referencing a first catalogue information. The image capture device may include a camera or a scanner. In some embodiments, the camera or scanner may be operably coupled with a smart device, such as a smart phone. In some embodiments, the image capture device may be integrated with the smart device. The first scannable code may, in some embodiments, include a quick response (QR) code, a bar code, or other scannable code. The first catalogue information may include information referenced by the QR code. The first catalogue information may comprise information related to a characteristic common to items that will be placed in a container to be moved or stored. Such a characteristic may include a location to where items within the container will be moved (i.e., a new home or office), a storage location at which items will be stored, an owner, a theme or an arbitrary characteristic assigned by a user, such as a color.

In some embodiments, step 310 may further comprise wherein the smart device may comprise a processor. The method may comprise receiving at the processor, the first catalogue information. The method may further comprise storing, in a memory or the smart device, the first catalogue information.

In some embodiments, the method may comprise step 320, scanning or capturing, via an image capture device, an image of a second scannable code, the second scannable code referencing a second catalogue information. The second scannable code may be similar to the first scannable code, i.e., a QR code, a bar code, or other scannable code. The second catalogue information may comprise information regarding the location to where items may be moved or transferred, such as a destination home or a destination office or other location.

In some embodiments, the method at step 320 may comprise receiving, at the processor, the second catalogue information.

The method may comprise step 330, storing, in a memory, the second catalogue information. The method may further comprise correlating, in the memory via the processor, the second catalogue information with the first catalogue information, and storing the correlated information in the memory.

In some embodiments, the method may comprise wherein the first catalogue information is pre-stored in the memory and wherein receiving the image of the first scannable code further comprises correlating, via a processor, the first scannable code with the pre-stored catalogue information.

In some embodiments, the method may comprise step 331, scanning or capturing, via an image capture device, an image of a third scannable code, the third scannable code referencing a third catalogue information. The third scannable code may be similar to the first scannable code, i.e., a QR code, a bar code, or other scannable code. The third catalogue information may comprise information related to a temporary and/or an extended storage space. A temporary storage space may comprise a moving van or, a trailer, or other short-term storage. A long-term storage may comprise a long-term storage facility, a garage, a closet, or other location where items may be stored for a longer period of time.

In some embodiments, the method at step 331 may comprise receiving, at the processor, the third catalogue information.

The method may comprise step 332, storing, in a memory, the third catalogue information. The method may further comprise correlating, in the memory via the processor, the third catalogue information with the first catalogue information, and storing the correlated information in the memory.

In some embodiments, the method may comprise wherein the third catalogue information is pre-stored in the memory and wherein receiving the image of the third scannable code further comprises correlating, via a processor, the third scannable code with the pre-stored catalogue information.

In some embodiments, the method may comprise correlating or associating the first catalogue information with the second catalogue information. In some embodiments, the method may comprise correlating or associating the first catalogue information with the third catalogue information. In some embodiments, the method may comprise correlating or associating the first catalogue information with the second catalogue information and the third catalogue information.

In some embodiments, the method may comprise step 340, recording storage contents. The method may comprise capturing, via the image capture device, at least one image of a content operable to be stored within a container, and correlating, via a processor the at least one image with the first catalogue information. A content operable to be stored within a container may comprise a household or a commercial object. In some embodiments, the method may comprise, correlating, via a processor the at least one image of content with the first catalogue code. The at least one image of content may be catalogued with each of the first catalogue code and the second catalogue code.

In some embodiments, the method of recording storage contents may comprise entering, via an input interface, a text description of a content operable to be stored within a container. The input interface may comprise a keyboard as displayed on a smart device. In some embodiments, the method may comprise correlating, via the processor, the text description with the first catalogue information. The method may comprise correlating, via the processor, the text description with the first catalogue.

The method may comprise recording or retrieving, via the processor and network or cloud connections, the value of items. The method may comprise tracking the location of items to be moved, stored, or disposed, and maintaining a chain of custody of the items.

The method may comprise step 350, receiving, at a processor, a prompt to display the storage contents. The prompt may comprise a user requesting, via the application 110 having a user interface operably coupled with the processor, that the contents be displayed.

In some embodiments the method of step 360 may comprise retrieving, from the memory, the contents, and displaying, on a display, the contents. The contents may be displayed in relation to the first catalogue information, in relation to the second catalogue information, in relation to the third catalogue information, or the first catalogue information, the second catalogue information, and the third catalogue information. The contents may be displayed as described in images and/or text.

In some embodiments, the method may comprise step 370, receiving, at the processor, a prompt to display, on a display an advertisement. The prompt be automatically generated. In some embodiments, a user may be referred to use the system. In such cases, the system may send to the user an invitation via an identifying address, such as a phone number or an email address. Upon sending an invitation to the user, the system may be prompted to display on the display an advertisement on behalf of the person and/or business that originally referred the user to the system. The advertisement may comprise text, a still image, audio, and/or video.

The advertised content may be stored in the memory. In some embodiments, an update to the advertisement content may be received at a transceiver and communicated to the memory via the processor. The updated content may comprise text, a still image, audio, and/or video. In some embodiments, the prompt may comprise initiating the system. Initiating the system may comprise opening a software application 110 on a user's smart device.

In some embodiments, the method may include displaying a custom advertisement upon opening the application 110.

In some embodiments, the method may comprise recalling or generating, at the processor, upon receiving a second prompt from an input source, a first unique scannable code, such as a QR code, a bar code, or other scannable code. The first unique scannable code may be used to identify common characteristic of items to be placed within a container.

In some embodiments, the method may comprise recalling, or generating, at the processor, upon receiving a third prompt from an input source, a second unique scannable code, such as a QR code, a bar code, or other scannable code. The second unique scannable code may be used to identify a destination location. The method may include correlating in the memory, via the processor, the first unique scannable code with the second unique scannable code.

In some embodiments, the method may comprise recalling or generating, at the processor, upon receiving a fourth prompt from an input source, a third unique scannable code, such as a QR code, a bar code, or other scannable code. The third unique scannable code may be used to identify a storage location. The method may include correlating in the memory, via the processor, the first unique scannable code with the third unique scannable code.

In some embodiments, the method may include displaying an advertisement from a sponsor or a referral partner each time the first unique scannable code and/or the second unique scannable code is generated, or at random times a scannable code is generated.

In some embodiments, the method may include printing, in response to a command, the first unique scannable, the second unique scannable code, and/or the third unique scannable code and placing the first unique scannable code, the second unique scannable code, and third unique scannable code on respective labels that may be associated with respective container labels, room labels, and/or storage location labels. In some embodiments, the method may include automatically printing the appropriate color and room name on the label(s).

In some embodiments, the method may include generating a location map within the application 110, wherein the location map may display a map of the building to where items are to be moved. The method may include displaying a room within the location map to have an alternate identifying marker that corresponds with the first identifying marker and the second identifying marker. For example, a first alternate identifying marker may correspond to a room, such as a bedroom, to where items will be moved and may comprise a color, such as red. A second alternate identifying marker may correspond to a container to be moved to the bedroom, and the second alternate identifying marker may comprise the color red. The map alternate identifying marker may correspond to a room displayed on the map, such that the room on the location map is colored in red, easily correlating the map, the first label and the second label. The method may further include printing out the map and displaying the map at various locations throughout the building.

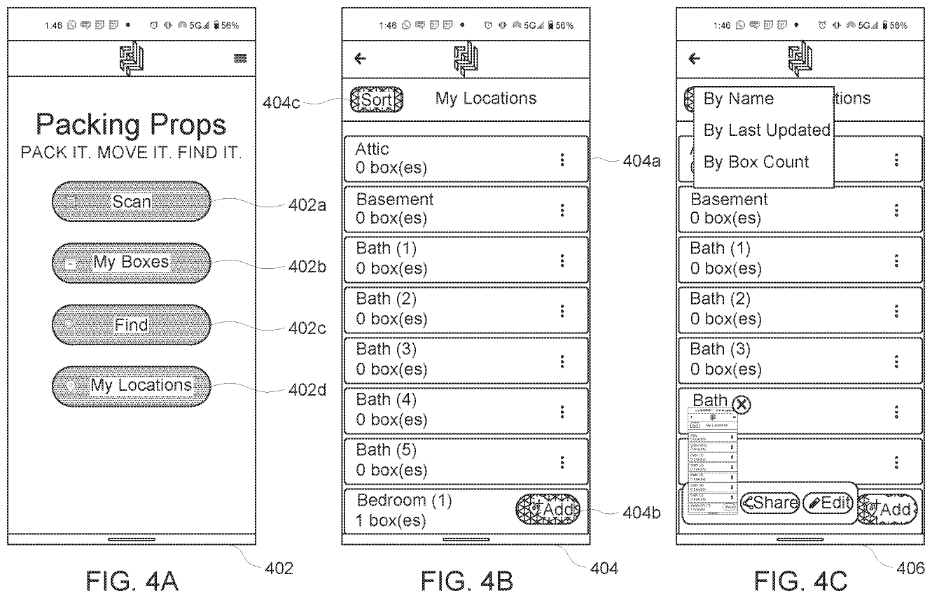

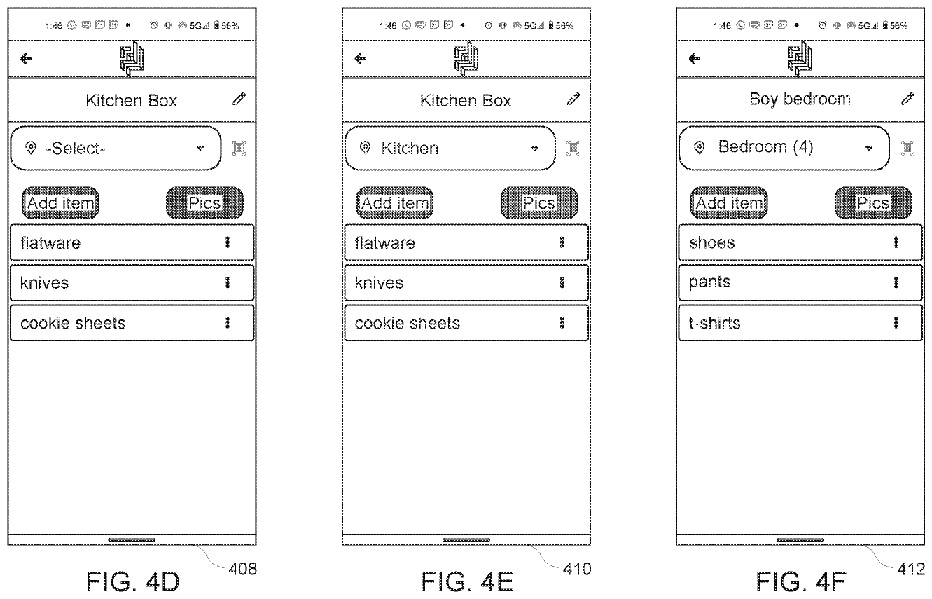

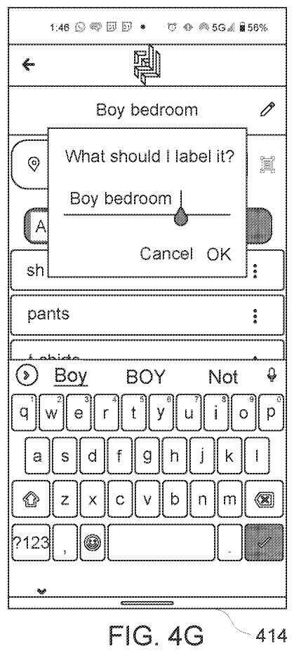

FIGS. 4a-4g illustrate an exemplary user interface of the organization and storage system implemented at a smart device 120, in accordance with various embodiments of the present invention. The user interface 402 depicts an input and display screen of the application using the system.

According to one embodiment, the user interface 402 may comprise a window providing a user with various options to “Scan”, 402a, or view 402b boxes in inventory. In some embodiments, the application 110 may comprise a find button 402c operable to activate a search within the memory 206 for items and/or containers catalogued within the application 110. In some embodiments, the application 110 may comprise a locations option 402d operable to display locations of certain contents catalogued within the application, as shown in further detail in FIG. 4B.

As illustrated in FIG. 4b, upon selecting locations 402d, a user may view all of the location's containers may be assigned to be or may be stored in. The locations 404a may include an attic, a basement, a bathroom, a bedroom, a living room, a kitchen, closet, garage, shed, laundry, playroom, pantry, storage, utility, etc. Locations may be added via the add 404b button. Further, items may be sorted via the sort 404c button.

As illustrated in FIG. 4c, the application may provide a user with the option to sort locations by name, by last updated, or by box count.

In some embodiments, as shown in FIG. 4d, upon selecting a common characteristic, such as, for example a room of origin or destination, such as kitchen (or before selecting the common characteristic 408a and adding the common characteristic at a later time), a user may populate that common characteristic family with a variety of boxes. For example, a user may select “kitchen” as a common characteristic. A user may then subsequently assign to the various “kitchen” boxes items to be stored within the boxes. In order to select a common characteristic, such as “kitchen” and add “Kitchen Box” to the inventory, the user may scan a scannable code to select the common characteristic. The application may connect to the image capture device operably coupled with the smart device by selecting button 408b. Upon scanning the “Kitchen” scannable code, the “Kitchen Box” is correlated with the “Kitchen” location, as shown in 410a of FIG. 4c.

FIG. 4f illustrates another box and location correlation with associated box inventory. FIG. 4g illustrates the ability to relabel a box name manually.

Some embodiments may include the system 100 of FIG. 1a including multiple other features. For example, system 100 may include displaying an advertisement upon opening the application 110 or access certain features of the application 110. In some embodiments an advertisement may include an advertisement for professional services, such as an advertisement for real estate agent services, moving company service, property management services or the like.

In some embodiments, the upon opening the application 110 of system 100, the application 110 may display the name, logo, and associated brand identity of a sponsor or professional services provider.

In some embodiments, the application 110 of system 100 may have multiple uses. For example, the application 110 of system 100 may be operable to provide organization for individual's storage at a home, office, or storage unit. The application 110 of system 100 may be operable to receive an additional input from a user. The additional input may comprise an input to identify a particular location, such as home, office, garage, shed, or other location. A further input may be available, such as a further input to a more specific location within the first location, such as a particular cabinet or a particular shelf within the particular location.

In some embodiments, the application 110 may associate a color with particular category of storage items. The storage location of some items may be identified within the application 110 of system 100 by a color. In some embodiments, a user may select or identify the color that the user wants to associate with a particular grouping of items. For example, a user may choose to store decorations for a holiday, such as Christmas, and may choose to illustrate an identifier within the application 110 of system 100 by the color red. The identifier may comprise the letters of the description, a highlighted row, or a shape filed in with the identified color next to the words describing the stored items.

In some embodiments, the application 110 of system 100 may comprise sharing the information entered within the application 110 with multiple parties. The application 110 of system 100 may comprise multiple user interfaces with varying permissions. The application 110 of system 100 may include a first user interface. The first user interface may enable a first user to catalogue an inventory of various items in a first location. In some embodiments the first user may include, for example a moving company.

In some embodiments the application 110 of system 100 may include a second user interface. The second user interface may enable a second user to view and edit the entries of the first user. The application 110 of system 100 may further allow the second user to export the contents of the inventoried items to a third party. In some embodiments, said third party may be able to access the application 110 through a third user interface.

The application 110 of system 100 may comprise a fourth user interface. The fourth user interface may enable a fourth user to view the entries of the first user, the second user or the third user, and each of them may in some embodiments, be able to view the entries of the other users. In some embodiments, the system may be customized to limit which users can see entries from other users.

Such an application 110 may be useable for home or professional use, and may be used by movers, disaster restorations companies, insurance companies, homeowners, or all companies simultaneously and symbiotically.

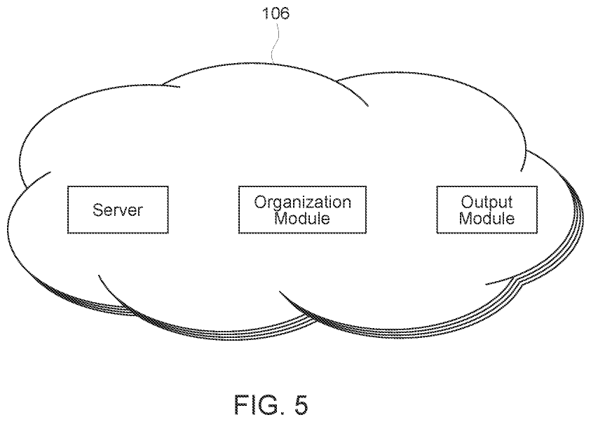

FIG. 5 illustrates an exemplary cloud architecture 106 for implementation of for a storage and organization system, in accordance with some embodiments of the present invention.

The cloud architecture 106 may include a server 502, an organization module 504, and an output module 506. In one embodiment, the application 110 at the smart device 120 may be operable to organize the received data organization module 504 available at the cloud architecture 106. The server 502 may be configured to receive a data to be organized from smart device 120, as depicted in FIG. 1a. The server 502 in combination with the organization module 504 may be configured to organize the received images and text. Further, the output module 506 may be configured to transmit the organized data back to the smart device which transmitted the initial non-organized data. The organized data is subsequently received by the mobile device (e.g., smart device 120) and displayed to the user.

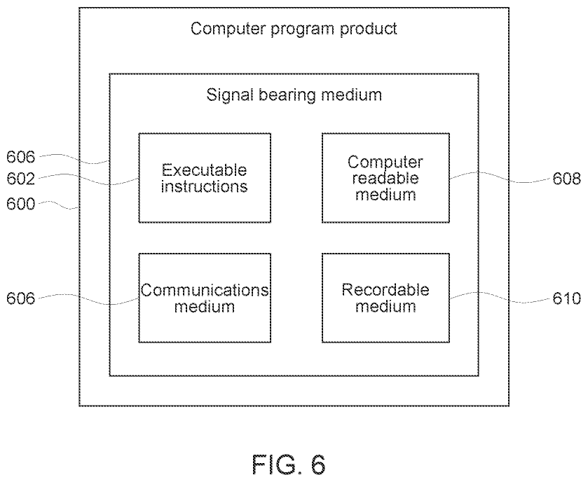

FIG. 6 illustrates an exemplary computer program product 600 that is configured to provide organization and storage system, in accordance with various embodiments of the present invention.

The computer program product 600 may correspond to a program product stored in memory 206 or a program product stored in the form of processor executable instructions stored in smart device 120 smart device 120.

Computer program product 600 may include a signal bearing medium 604. Signal bearing medium 604 may include one or more instructions 602 that, when executed by, for example, a processor or controller, may provide the functionalities described above to provide an organization and storage system.

In some implementations, signal bearing medium 604 may encompass a computer-readable medium 608, such as, but not limited to, a hard disk drive, a Compact Disc (CD), a Digital Video Disk (DVD), a digital tape, memory, etc. In some implementations, signal bearing medium 604 may encompass a recordable medium 610, such as, but not limited to, memory, read/write (R/W) CDs, R/W DVDs, etc. In some implementations, signal bearing medium 604 may encompass a communications medium 606, such as, but not limited to, a digital and/or an analog communication medium (e.g., a fiber optic cable, a waveguide, a wired communications link, a wireless communication link, etc.). Thus, for example, program product 600 may be conveyed to one or more components of the control unit 60 or mobile device 31 by an RF signal bearing medium 604, where the signal bearing medium 604 is conveyed by a wireless communications medium 606 (e.g., a wireless communications medium conforming with the IEEE 802.11 standard).

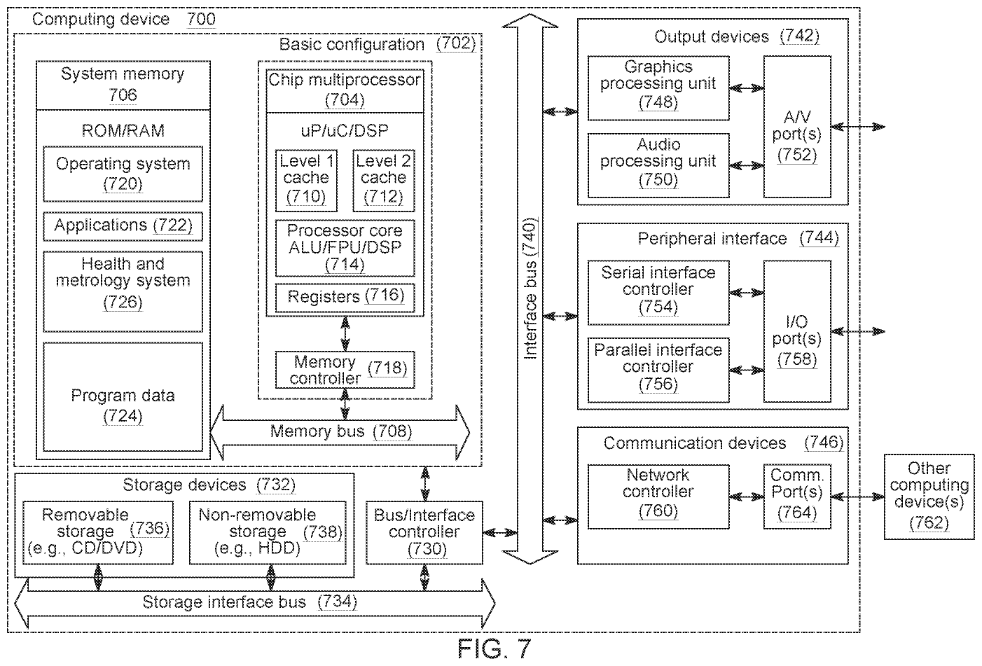

FIG. 7 is a block diagram illustrating an exemplary computing device that is configured to provide a storage and organization system, in accordance with various embodiments of the present invention. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (p,P), a microcontroller (piC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof System memory 706 may include an operating system 720, one or more applications 722, and program data 724. Application 722 may include a document interaction evaluation algorithm 726 that is arranged to perform the functions as described herein including those described with respect to system 100 of FIGS. 1-6. Program data 724 may include document interaction evaluation data 728 that may be useful for implementation of a document interaction evaluator based on an ontology as is described herein. In some embodiments, application 722 may be arranged to operate with program data 724 on operating system 720 such that implementations of evaluating interaction with document based on ontology may be provided. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more AN ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A storage system, comprising:
at least one common characteristic label comprising a first scannable code correlated to a first catalogue information;
at least one origin or destination label having a second scannable code correlated to a second catalogue information;
a smart device having a processor, a memory, and a transceiver, the smart device being operable to receive an input from an image capture device,
wherein the smart device is operable to receive from an image capture device a scan of each of the first scannable code, and receive the first catalogue information, and of the second scannable code, and receive the second catalogue information,
wherein the processor is operable to associate the second catalogue information with the first catalogue information;
wherein the processor is operable to access, from the memory, origin data associated with the second catalogue information,
wherein the processor is operable to access, from the memory, origin or destination data associated with the first catalogue information, and
the smart device being operable to receive, from an image capture device, images of items stored in at least one container,
wherein the memory is operable to store the images and wherein the processor associates, in the memory, the images with the first catalogue information.

2. The storage system of claim 1, wherein the smart device comprises an informational input operable to receive a user input, wherein the user input comprises a description of items to be stored within the at least one container, wherein the smart device is operable to store in the memory the description of items, and wherein the smart device is operable to associate the description of items with the second catalogue information.

3. The storage system of claim 1, wherein the common characteristic label further comprises an origin or destination identifying marker.

4. The storage system of claim 2, wherein the origin or destination label further comprises a container identifying marker, wherein the origin identifying marker and the container identifying marker are correlated with each other.

5. The storage system of claim 4, wherein the smart device is operable to receive a third catalogue information associated with a storage location, and wherein the smart device is operable to correlate the first catalogue information with the third catalogue information and display, on a display, the storage location of items associated with the first catalogue information.

6. The storage system of claim 5, further comprising multiple access points to accommodate various users, wherein access to the data is customized to each user.

7. The storage system of claim 1, wherein the memory and the processor are operable to display on a display information related to advertisement of services.

8. The storage system of claim 5, wherein the at least one location label and the at least one container comprise a display of advertisement of services.

9. A method of organizing storage information, comprising:
scanning, via an image capture device, a first scannable code on at least one label representing a common characteristic of items;
receiving a first catalogue information associated with the first scannable code, at the processor;
scanning, via an image capture device, a second scannable code on at least one container label;
receiving a second catalogue information associated with the second scannable code, at the processor;
storing within a memory, the first catalogue information with the second catalogue information;
associating, via a processor, the second catalogue information with the first catalogue information;
accessing, via the processor, from a memory, common characteristic data associated with the first catalogue information; and
accessing, from the memory, origin or destination data associated with the second catalogue information.

10. The method of claim 9, further comprising:
receiving, from an image capture device, at least one image of a content of a container having a common characteristic with other container contents;
storing, in the memory, the at least one image;
associating, via the processor, the at least one image with the first catalogue information.

11. The method of claim 9, further comprising:
receiving, at an informational input, a user input, wherein the user input comprises a description of at least one item stored within the at least one container; and
associating, via the processor, the informational input with one of the first catalogue information and the second catalogue information.

12. The method of claim 11, further comprising accessing, by a third party, data associated with the first catalogue information and the second catalogue information.

13. The method of claim 11, further comprising, receiving a third catalogue information, at the processor, the third catalogue information being correlated with a location of temporary or permanent storage.

14. The method of claim 13, further comprising:
categorizing items to be stored, moved, or disposed of;
tracking the location of items to be stored, moved, or disposed of;
maintaining a chain of custody log of items to be stored, moved, or disposed of.

15. The method of claim 9, further comprising displaying, on a display, a customized image.

16. A system for organizing information related to the organization and storage of items, comprising:
a smart device, comprising a processor and a memory, the smart device being operable to receive:
a first input related to a first catalogue information, the first catalogue information being correlated to a common characteristic of items;
a second input related to a second catalogue information, the second catalogue information being related to at least one of an origin or a destination of items sharing the common characteristic;
wherein the smart device stores, in the memory, the first catalogue information and the second catalogue information, and wherein the smart device associates, via the processor, the first catalogue information with the second catalogue information;
a data entry portal operable to receive information from a first user input regarding the first catalogue information and the second catalogue information;
a portal accessible by a second user on a separate device, the access point enabling the second user to view data entered by the first user, wherein the second device is operable to access, from a memory, data associated with the first catalogue information and the second catalogue information.

17. The system of claim 16, wherein the smart device is further operable to receive, from an image capture device a scan of at least a third catalogue information, correlated with a temporary or permanent storage location, and associate the third catalogue information with the first catalogue information and the second catalogue information.

18. The system of claim 17, further comprising an access point for at least a second user on a separate device, wherein the second user may view the content entered.

19. The system of claim 17, further comprising associating a value to items associated with the first catalogue information.

20. The system of claim 17, further comprising a log of the chain of custody of items associated with the first catalogue information.
